(19) United States
(12) Patent Application Publication
(10) Pub. No.: US 2026/0085885 A1
(43) Pub. Date: Mar. 26, 2026

(54) DRYING SYSTEM AND METHOD FOR DRYING A COATING FOR TINS

(71) Applicant: BELVAC PRODUCTION MACHINERY, INC., Lynchburg, VA (US)

(72) Inventor: Ulf REINHARDT, Teutschenthal (DE)

(21) Appl. No.: 19/111,229

(22) PCT Filed: Sep. 13, 2023
(86) PCT No.: PCT/IB2023/059060

§ 371 Date: Mar. 12, 2025

(30) Foreign Application Priority Data
Sep. 13, 2022 (DE) 10 2022 123 370.7

(51) Int. Cl. F26B 21/10; F26B 3/04; F26B 15/18; F26B 23/02

(52) U.S. Cl. CPC F26B 21/35; F26B 3/04; F26B 15/18; F26B 23/022

(57) ABSTRACT

A drying system for drying a coating for tins, including a drying chamber with a drying line having a pre-heating section and a polymerization chamber, a conveyor device with which the tins can be moved, and a heating system for applying a temperature-controlled process fluid to the tins. The heating system is coupled to a control device for signal communication. The pre-heating section has a first pre-heating chamber and a second pre-heating chamber downstream of the first pre-heating chamber. The control device is designed to control the heating system such that the tins in the first pre-heating chamber are heated to a first temperature, and the tins in the second pre-heating chamber are heated to a second temperature, wherein the second temperature is higher than the first temperature.

### FIELD OF TECHNOLOGY

The invention relates to a drying system and method for drying a coating for tins.

### PRIOR ART

Drying systems for drying a coating for tins are basically known. Such drying systems can be designed to dry a tin coating on an inner or outer surface of a tin. Drying systems for drying a tin coating on the inside of tins are also referred to as internal baking ovens or IBOs. Drying systems for drying tin coatings on the outer surface of a tin are also referred to as pin ovens.

In a process step before the drying system, a varnish is applied to the interior wall forming the cavity. In the drying system, this paint is dried and/or polymerized. To do this, the tins are moved through the drying system and exposed to hot air. Similarly, a paint is applied to the outer wall of the tins and then dried and/or polymerized in a pin oven.

Drying systems can have several drying chambers arranged one behind the other, in which water contained in the paint evaporates, the tins are heated to a polymerization temperature and/or held at the polymerization temperature for a predefined period of time for polymerization.

Condensate is produced when drying tin coatings. In addition, particulates are deposited during drying. The condensate and the particulates clog the drying systems mentioned above to such an extent that they have to be cleaned at regular intervals, which is a costly and time-consuming process. In normal operation, such drying systems are cleaned manually and/or with dry ice. This cleaning is so time-consuming that several million tins cannot be produced per cleaning process. Furthermore, such cleaning can be hazardous to the health of the cleaning person.

In the past, coatings containing bisphenol were regularly used, with the bisphenol (BPA) acting as a binder. However, bisphenol can have a carcinogenic effect, which is why the use of coatings containing BPA has been banned in a number of countries. One disadvantage of using BPA-free coatings is that they lead to significantly higher condensate deposits and higher particulate contamination. The already existing problem of condensate and particulate deposition is therefore exacerbated by the use of BPA-free coatings.

The invention is aimed at providing a drying system and method that alleviates or eliminates one or more of the disadvantages mentioned. In particular, the invention is aimed at providing a solution that reduces condensation and/or particulate contamination during the drying of tin coatings.

### SUMMARY OF THE INVENTION

This task is solved by means of a drying system and method according to the features of the independent claims. Further advantageous embodiments of these aspects are indicated in the respective dependent patent claims. The features described and shown in the patent claims, the description and the drawings can be combined with each other in any technologically useful way, whereby further embodiments of the invention are indicated.

According to the first aspect, the above-mentioned task is solved by a drying system for drying a coating for tins, comprising a drying chamber having a drying line that has a pre-heating section and a polymerization chamber, a conveyor device with which the tins can be moved through the drying chamber, a heating system for applying a temperature-controlled process fluid to the tins within the drying chamber, wherein the heating system is coupled to a control device for signal communication, the pre-heating section has a first pre-heating chamber and a second pre-heating chamber downstream of the first pre-heating chamber, and the control device is set up to control the heating system in such a way that the tins in the first pre-heating chamber are heated to a first temperature, preferably below 80° C., in particular below 70° C., for example 65° C., and the tins in the second pre-heating chamber are heated to a second temperature, preferably below 120° C., in particular below 110° C., for example 100° C., wherein the second temperature is higher than the first temperature, so that a temperature gradient of the tins along the drying line is low to such an extent that a sublimation of the tin coating is reduced in order to prevent condensate formation, and/or wherein the heating system is arranged and designed to act on the process fluid at a transfer temperature of less than 800° C., in particular less than 700° C., preferably less than 600° C., on the process fluid, such that particulate-containing combustion products are reduced in order to minimize particulate contamination.

The invention is based on the realization that the condensate formation within the drying system is essentially caused by sublimation of the tin coating or the lacquer forming the tin coating. In the prior art, the often water-based tin coatings are usually heated so quickly that the water evaporates quickly and carries components of the tin coating or the varnish with it during the evaporation process. The effect underlying this finding is also referred to as steam distillation.

The invention is also based on the realization that by slowing down the heating of the tins in the first section of the drying line, the sublimation of the tin coating can be reduced or avoided, thus reducing condensate formation. To achieve this, the drying system comprises a first pre-heating chamber and a second pre-heating chamber, wherein the tins are heated to a lower temperature in the first pre-heating chamber than in the second pre-heating chamber.

Furthermore, the invention is based on the realization that the process fluid is advantageously heated only at a low transfer temperature of less than 800° C., thereby reducing particulate-containing combustion products to minimize particulate contamination of the drying system. It should be noted that the process fluid in such drying systems usually does not consist of fresh air, but is usually operated by means of circulating air in order to improve energy efficiency. This circulating air usually already contains vaporized can coating components, which, when reheated, for example by a gas burner at 1200° C., generate particulates that subsequently contaminate the drying system. The invention is also based on the realization that this particle deposit can be reduced by using a transfer temperature of less than 800° C., for example with a porous burner, which will be explained in more detail below.

The drying system is designed to dry a coating for tins. The tins may be tins for holding food, in particular food and/or drinks. The tin coating may be a varnish for coating an inner and/or outer wall of a tin. The drying system as such may be an interior drier and/or a pin oven.

The drying system comprises the drying chamber with the drying line, which has a pre-heating section and a polymerization chamber. The drying chamber preferably comprises an inlet side and an outlet side. The drying chamber also preferably has a chamber inlet on the inlet side for the tins to enter and a chamber outlet on the outlet side for the tins to exit. The tins are moved between the chamber inlet and the chamber outlet, for example, by the conveyor belt of the conveyor device. The conveyor belt can, for example, be permeable to fluids. The polymerization chamber preferably has a heating section and a temperature maintenance section, wherein the tins are heated in the heating section to a polymerization temperature, for example from 100° C. to 200° C., and are maintained at the polymerization temperature in the temperature maintenance section. The heating section and/or the temperature holding section can be formed as separate subchambers, which, for example, are fluidically separated from each other or can be separated. A fluidic separation can be effected, for example, with an airlock.

In an IBO, the tins are usually exposed to a hot process fluid from above, which then passes through the conveyor belt and from there is fed to either a circulating air and/or an exhaust air system. Furthermore, the drying chamber can have different flow media to enable the tins to be exposed to the process fluid as evenly as possible.

In addition, the drying chamber preferably has one, two or more fluid supply lines, which are particularly arranged and designed to supply a circulating air and/or a fresh air to the drying chamber. Furthermore, it is preferred that the drying chamber is essentially fluid-tight, for example by means of a chamber wall.

The drying system comprises the conveyor device by which the tins can be moved through the drying chamber. The conveyor device may, for example, comprise the conveyor belt described above or may be in the form of a pin chain.

The drying system comprises the heating system for applying the temperature-controlled process fluid to the tins inside the drying chamber. For this purpose, the heating system can have a fluid supply, fluid outlets and/or a circulating air supply. It is particularly preferred that the heating system is arranged and designed to apply the temperature-controlled process fluid to the tins in the pre-heating section, in particular in the first pre-heating chamber and the second pre-heating chamber, and in the polymerization chamber, independently of one another, with the temperature-controlled process fluid, so that the process fluid supplied to the aforementioned chambers can be adjusted and/or controlled with respect to a fluid volume and/or a fluid temperature in a chamber-dependent manner. Preferably, the temperature-controlled process fluid is supplied to the polymerization chamber in such a way that the tins in the polymerization chamber have a temperature between 150° C. and 250° C., for example 200° C.

The process fluid is preferably air. The process fluid may comprise fresh air and/or circulating air or consist of it or them.

In one alternative, the heating system is coupled to the control device for signal communication. The pre-heating section has the first pre-heating chamber and the second pre-heating chamber downstream of the first pre-heating chamber. Downstream is to be understood here in particular in the direction of movement of the tins. The tins thus enter the drying system, first pass through the first pre-heating chamber, then enter the second pre-heating chamber and are then led through the polymerization chamber.

The control device is designed to control the heating system in such a way that the tins in the first pre-heating chamber are heated to a first temperature and the tins in the second pre-heating chamber are heated to a second temperature. This causes the tins in the first pre-heating chamber to be heated slowly at first to a lower temperature, in particular below 80° C. As a result, the expected sublimation is reduced. In the second pre-heating chamber, the tin is then heated to such a temperature that the water components of the tin coating are vaporized.

The first pre-heating chamber and the second pre-heating chamber are designed as separate chambers. In particular, these can have different drying line lengths so that the temperature gradient of the tins can be adjusted as required.

It is preferred that the first drying chamber, the second drying chamber and/or the conveyor device are arranged and designed and/or the control device is set up in such a way that the tins are moved through the first drying chamber with a first throughput time between 20-90 seconds, in particular between 30-60 seconds, and through the second drying chamber with a second throughput time between 20-90 seconds, in particular between 30-60 seconds.

In a second alternative, the heating system is arranged and designed to act on the process fluid at a transfer temperature of less than 800° C., so that particulate-containing combustion products are reduced in order to reduce particulate contamination. The transfer temperature is to be understood in particular as the temperature at which the process fluid is heated. This may be, for example, a unit of the heating system that heats the process fluid, such as an electric heating wire or a porous burner. This is in contrast to the approach taken in the prior art, in which the process fluid is typically heated with a gas burner, the gas flame of which is, for example, 1200° C. Thus, the heating system described above enables the process fluid to be heated at a lower temperature, namely below 800° C., so that particle formation is reduced or avoided.

In a preferred embodiment of the drying system, it is provided that it comprises both alternatives, namely that the heating system is coupled to the control device for signal communication, the pre-heating section has the first pre-heating chamber and the second pre-heating chamber downstream of the first pre-heating chamber, and the control device is set up to control the heating system in such a way that the tins in the first pre-heating chamber are heated to the first temperature and the tins in the second pre-heating chamber are heated to the second temperature, wherein the second temperature is higher than the first temperature, so that the temperature gradient of the tins along the drying line is low to such an extent that sublimation of the tin coating is reduced, in order to prevent the formation of condensation, and that the heating system is arranged and designed to act on the process fluid at a transfer temperature of less than 800° C., so that particulate-containing combustion products are reduced in order to reduce particulate contamination.

A preferred embodiment of the drying system is characterized in that the first pre-heating chamber, the second pre-heating chamber and the polymerization chamber each have an exhaust fan, so that a first exhaust air volume of an exhaust air of the first pre-heating chamber, a second exhaust air volume of an exhaust air of the second pre-heating chamber and a third exhaust air volume of an exhaust air of the polymerization chamber can be adjusted independently of one another.

For example, the first pre-heating chamber can have a first exhaust fan, the second pre-heating chamber can have a second exhaust fan and the polymerization chamber can have a third exhaust fan. These exhaust fans can be coupled in particular with the exhaust air ducts described in more detail below. Fresh air volumes in the individual chambers can be adjusted independently of one another by means of separate exhaust fans.

In a further preferred embodiment of the drying system, the first pre-heating chamber has a first drying line, the second pre-heating chamber has a second drying line and the polymerization chamber has a polymerization line, and the first drying line is longer than the second drying line, and/or the first drying line and the second drying line together are longer than the polymerization line.

The temperature gradient during heating of the tins is kept low by means of a long first drying line, since the first temperature is lower than the second temperature. This low temperature gradient ensures that sublimation is kept low or avoided. In particular, it is preferred that the pre-heating line, consisting of the first drying line and the second drying line, is of such a length that sublimation is avoided. This can be achieved, inter alia, by the pre-heating line being longer than the polymerization line.

A preferred design of the drying system is characterized in that the first pre-heating chamber, the second pre-heating chamber and the polymerization chamber each have an exhaust duct for discharging exhaust air, so that the exhaust air from the first pre-heating chamber, the second pre-heating chamber and the polymerization chamber is essentially not mixed with each other, thus reducing condensation in the exhaust air ducts.

The invention was also based on the realization that the exhaust ducts in drying systems, which are usually contaminated, are necessary because the exhaust air flows from different chambers have different temperatures. As soon as these exhaust air flows with different temperatures are mixed together, condensate usually forms. This condensate settles in the exhaust air ducts and clogs them, so that the aforementioned cleaning becomes necessary. The separate embodiments of the exhaust air ducts prevent this condensate formation.

It is particularly preferred that these exhaust air ducts open into a condensate chamber and that the condensate chamber is arranged and designed to separate condensate from the exhaust air. The condensate is thus deliberately formed first in the condensate chamber and not in the exhaust air ducts themselves. The condensate chamber can, for example, have a cooling element so that condensate is deliberately formed on it.

In a preferred design of the drying system, it is further provided that the condensate chamber has a removable condensate separator. The condensate separator can, for example, be designed in the form of a cassette. A removable condensate separator has the advantage that it is easy to clean. The condensate separator can, for example, have the cooling element or be the cooling element.

In another preferred embodiment of the drying system, it is provided that this comprises a fluid interface that is arranged and designed to couple the first pre-heating chamber and/or the second pre-heating chamber fluidically and/or thermally to a device for manufacturing tins, so that the process fluid introduced into the first pre-heating chamber and/or second pre-heating chamber can be at least partially provided by the device for manufacturing tins and/or can be thermally influenced by the device for manufacturing tins.

The device for manufacturing tins can be any device within a canning plant. These are the devices that directly manufacture the tins, for example a forming device, but also an indirectly acting device, for example an exhaust air purifier. In particular, an exhaust air purifier has a high exhaust air temperature, which can be used to advantageously heat the process fluid. Thus, the energy efficiency of the drying system can be further increased. For this purpose, the exhaust air from the device for manufacturing tins can be used directly as a process fluid. Alternatively, this exhaust air can be thermally coupled to the process fluid by means of a heat exchanger, so that the thermal energy of the exhaust air from the device for manufacturing tins can be decoupled into the process fluid.

In a further preferred embodiment of the drying system, the heating system comprises a combustion unit and/or an electric heating unit, which is/are arranged and designed such that the transfer temperature is less than 800° C., preferably less than 700° C., in particular less than 600° C.

The combustion unit may be a gas burner, for example. The gas may be LNG, natural gas and/or hydrogen, for example. The electric heating unit may comprise a heating wire, for example.

In a further preferred embodiment, the combustion unit is or comprises a porous burner. In particular, a porous burner has a porous structure in which the combustion reaction takes place. Consequently, a porous burner usually has no open flame, so that the transfer temperature is reduced.

In a further preferred embodiment of the drying system, it is provided that a fresh air can be supplied to the process fluid so that a temperature of the process fluid can be adjusted by a fresh air volume of the fresh air. For this purpose, the drying system preferably has a supply air duct. In particular, it is preferred that the first pre-heating chamber, the second pre-heating chamber and/or the polymerization chamber each have a supply air duct.

A preferred design of the drying system is characterized by the fact that an airlock is arranged between the first pre-heating chamber, the second pre-heating chamber and/or the polymerization chamber, so that during normal operation, fluid exchange between the first pre-heating chamber, the second pre-heating chamber and/or the polymerization chamber is at least reduced.

An airlock of this kind between the individual chambers has the advantage that the target temperatures can be set particularly advantageously in a controlled manner, in particular that the predefined temperatures are actually set.

In a further preferred embodiment of the drying system, the first pre-heating chamber, the second pre-heating chamber and/or the polymerization chamber is provided with a cleaning unit that is arranged and designed to separate condensate and/or particulates.

The invention was based on the realization that condensate and/or particulates can also arise within the individual chambers, so that condensate and/or particulates can also settle in the chambers and not only in the exhaust air ducts during operation. The formation of condensate and/or particles can thus be further reduced by means of a single cleaning unit or by means of a cleaning unit arranged in the respective chambers. It is preferred that the first pre-heating chamber has a first cleaning unit, the second pre-heating chamber has a second cleaning unit and/or the polymerization chamber has a third cleaning unit.

In a preferred embodiment, it is provided that the cleaning unit, in particular the first cleaning unit, the second cleaning unit and/or the third cleaning unit, is designed to work mechanically, electrostatically and/or pressure-based. With such a cleaning unit, particulates and/or condensate can advantageously be separated in the individual chambers so that they accumulate specifically in the cleaning unit and do not contaminate the areas of the drying system that are difficult or impossible to clean.

According to a further aspect, the above-mentioned task is solved by a method for drying a coating for tins, in particular with a drying system according to one of the embodiments described above, comprising the steps of: Conveying the tins along a drying line with a first pre-heating chamber and a second pre-heating chamber downstream of the first pre-heating chamber, heating the tins to a first temperature, preferably below 80° C., in the first pre-heating chamber by exposure to a temperature-controlled process fluid, heating the tins to a second temperature, preferably below 120° C., in the second pre-heating chamber by exposure to a temperature-controlled process fluid, wherein the second temperature is higher than the first temperature, so that a temperature gradient of the tins along the drying line is low to such an extent that a sublimation of the tin coating is reduced in order to prevent condensate formation.

It may be preferred that the method comprises the step: Temperature-controlling the process fluid with a transfer temperature of less than 800° C., in particular less than 700° C., preferably less than 600° C., so that particulate-containing combustion products are reduced in order to minimize particulate contamination.

According to a further aspect, the above-mentioned task is solved by a method for drying a coating for tins, in particular with a drying system according to one of the embodiments described above, comprising the steps of: Conveying the tins along a drying line, which comprises a pre-heating section and a polymerization chamber, subjecting the tins to a temperature-controlled process fluid, and temperature-controlling the process fluid with a transfer temperature of less than 800° C., preferably less than 700° C., in particular less than 600° C., so that particulate-containing combustion products are reduced in order to decrease particulate contamination.

The method and its possible enhancements have features and method steps that make them particularly suitable for use in a drying system and its enhancement.

For further advantages, embodiment variants and embodiment details of the further aspects and their possible embodiments, reference is also made to the previous description of the corresponding features and embodiments of the device.

### BRIEF DESCRIPTION OF THE DRAWINGS

Preferred exemplary embodiments are explained by way of example with reference to the enclosed figures. It shows:

FIG. 1: a schematic, two-dimensional view of an exemplary embodiment of a drying system;

FIG. 2: a schematic, two-dimensional sectional view of the drying system shown in FIG. 1;

FIG. 3: a schematic view of an exemplary process for drying a coating for tins; and

FIG. 4: a schematic view of another process for drying a coating for tins.

### DESCRIPTION OF THE EMBODIMENTS

In the figures, identical or essentially functionally identical or similar elements are designated with the same reference symbols.

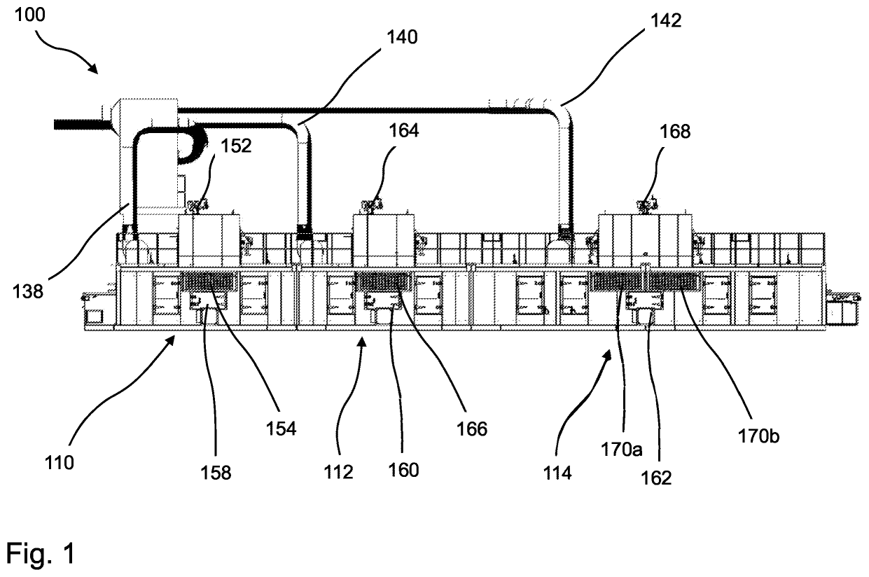

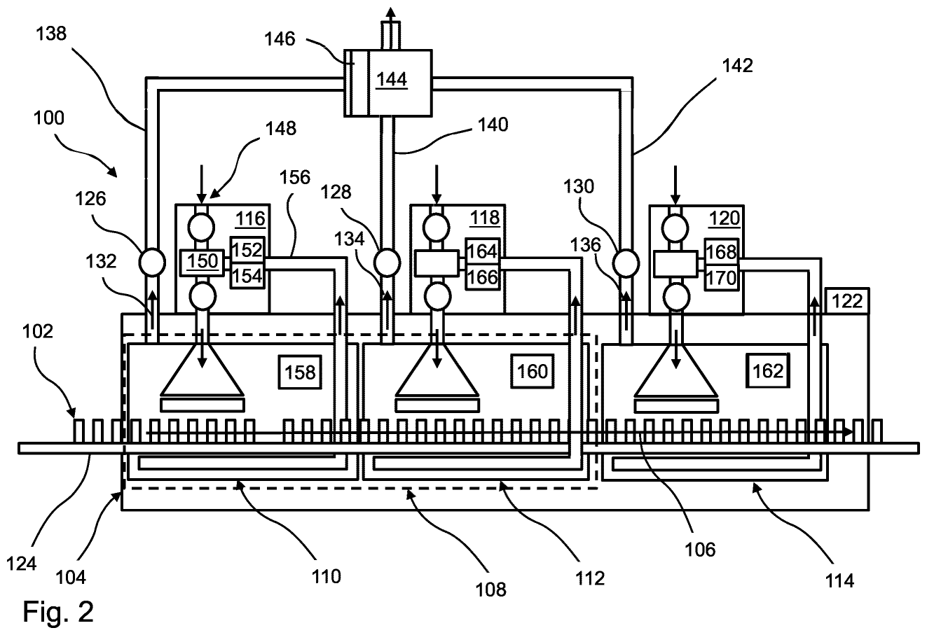

The drying system 100 shown in FIGS. 1 and 2 is designed to dry tins 102. The drying system 100 comprises a drying chamber 104, through which a drying line 106 extends. The drying line 106 extends from an entrance at the left end of the drying system 100 to an exit at the right end of the drying system 100. The drying chamber 104 comprises a pre-heating section 108, which comprises a first pre-heating chamber 110 and a second pre-heating chamber 112, and a polymerization chamber 114. The polymerization chamber 114 is shown in a simplified form, since it usually has two separate chambers, wherein the tins 102 are heated to a polymerization temperature in a heating chamber and the polymerization temperature is maintained in a temperature holding chamber.

In normal operation, the tins 102 are first moved by the conveyor device 124 into the first pre-heating chamber 110, then into the second pre-heating chamber 112 and then into the polymerization chamber 114. A heating system comprising a first heating unit 116, a second heating unit 118 and a third heating unit 120 is used to expose the tins 102 inside the drying chamber 104 to a temperature-controlled process fluid.

In particular, the tins 102 are exposed to the process fluid in such a way that they are first slowly heated in the first pre-heating chamber 110, for example to 65° C., then heated in the second pre-heating chamber 112 to a temperature of 100° C., and then heated in the polymerization chamber 114 to a polymerization temperature of, for example, 200° C. and held at this temperature.

For this purpose, the drying system comprises a control device (122) that is coupled to the heating system for signal communication. The control device 122 is designed to control the heating system in such a way that the tins 102 in the first pre-heating chamber 110 are heated to a first temperature, for example 65° C., and the tins 102 in the second pre-heating chamber 112 are heated to a second temperature, for example 100° C. This is done in such a way that the second temperature is higher than the first temperature. As a result, the temperature gradient of the tins 102 along the drying line 106 is set so low that sublimation of the tin coating of the tins 102 is reduced in order to prevent condensate formation. This is particularly due to the fact that heating the tin coating, which usually contains water, too quickly leads to blistering, so that the vaporizing water carries colorants with it.

The drying system 100 is designed so that a fluid can be routed in each of the chambers 110, 112, 114, this fluid can be circulated in the course of a circulating air and can also be disposed of. For this purpose, for example, the first pre-heating chamber 110 has a fluid interface 148. Fresh air can be supplied through the fluid interface 148. Alternatively, the first pre-heating chamber 110 can be coupled fluidically and/or thermally to a device for manufacturing tins by means of the fluid interface 148, so that the process fluid introduced into the first pre-heating chamber 110 can at least be partly provided by the device for manufacturing tins and/or can be thermally influenced by the device for manufacturing tins.

Furthermore, the first pre-heating chamber 110 comprises an air recirculation fan for circulating a circulating air, which fan is arranged between the chamber space and the mixing chamber 150. This circulating air is, inter alia, supplied from the pre-heating chamber 110 through the fluid recirculation unit 156 of the mixing chamber 150. Before the mixing chamber 150, the circulating air is thermally influenced, in particular temperature-controlled, by means of a first combustion unit 152 and/or a first electric heating unit 154. The circulating air, which acts as a process fluid, among other things, is temperature-controlled by the combustion unit 152 and/or the electric heating unit with a transfer temperature of less than 800° C., so that particulate-containing combustion products are reduced in order to minimize particulate contamination. The second pre-heating chamber 112 and the polymerization chamber 114 similarly comprise a second combustion unit 164, a second electric heating unit 166, a third combustion unit 168 and a third electric heating unit 170.

Furthermore, an exhaust air duct 138 is provided to remove initial exhaust air 132 from the first pre-heating chamber 110. The exhaust air duct 138 is coupled to an exhaust fan 126 for evacuating the initial exhaust air 132 from the first pre-heating chamber 110. In a similar manner, a second exhaust air 134 can be evacuated from the second pre-heating chamber 112 by means of a second exhaust fan 128 and a second exhaust duct 140. Furthermore, a third exhaust air 136 can be evacuated from the polymerization chamber 114 by means of a third exhaust fan 130 and a third exhaust air duct 142.

The exhaust air ducts 138, 140, 142 are each designed separately from one another and end in a condensate chamber 144. The condensate chamber 144 further comprises a condensate separator 146, at which condensate of the first exhaust air 132, the second exhaust air 134, the third exhaust air 136 is to be selectively separated. The condensate separator 146 can be designed to be removable from the condensate chamber 144. The condensate separator 146 can, for example, be designed in the form of a cassette and can be removed like a cassette.

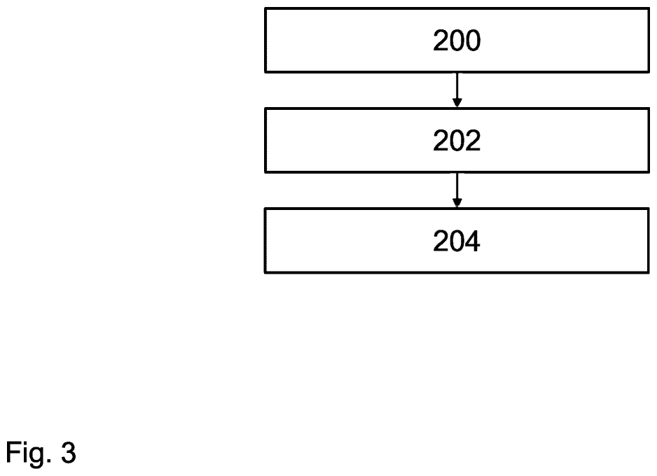

FIG. 3 shows a method for drying a coating for tins 102. The method comprises the step 200: Conveying the tins 102 along a drying line 106 having a first pre-heating chamber 110 and a second pre-heating chamber 112 downstream of the first pre-heating chamber 110.

Furthermore, the method comprises step 202: Heating the tins 102 to a first temperature, preferably below 80° C., in the first pre-heating chamber 110 by exposure to a temperature-controlled process fluid process fluid; Furthermore, the method comprises step 204: Heating the tins 102 to a first temperature, preferably below 120° C., in the first pre-heating chamber 112 by exposure to a temperature-controlled process fluid process fluid;

Steps 202 and 204 are carried out in such a way that the second temperature is higher than the first temperature, so that a temperature gradient of the tins 102 along the drying line 106 is low to such an extent that a sublimation of the tin coating is reduced in order to prevent condensate formation.

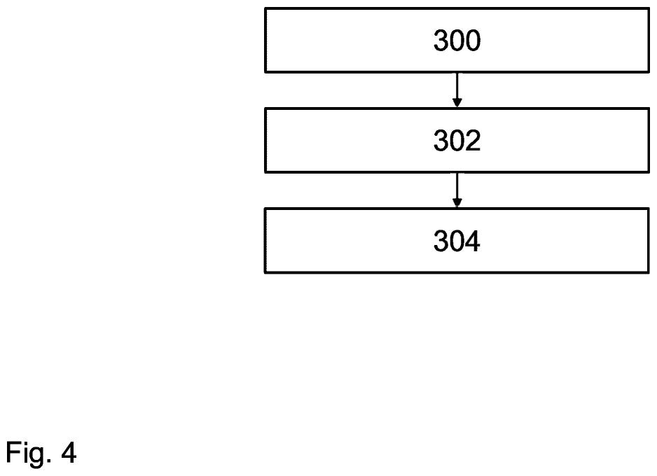

FIG. 4 shows a further method for drying a coating for tins 102. The method comprises the step 300: Conveying the tins 102 along the drying line 106, which has a pre-heating section 108 and a polymerization chamber 114. In step 302, the tins 102 are exposed to a temperature-controlled process fluid. In step 304, the process fluid is temperature-controlled at a transfer temperature of less than 800° C. so that particulate-containing combustion products are reduced in order to reduce particulate contamination.

The advantage of the drying system 100 described above and the corresponding methods is that the formation of condensation and particulates within the drying system 100 is significantly reduced. This is achieved, on the one hand, by reducing the sublimation during the heating of the tins or the tin coating by keeping a temperature gradient in the pre-heating section 106 low. This is made possible, among other things, by the fact that a first pre-heating chamber 110, in which the tins 102 are heated to a first temperature, and a second pre-heating chamber 112, in which the tins 102 are heated to a second temperature, are provided. This reduced or avoided sublimation is achieved in particular by the clever selection of the temperature, in particular the first temperature below 80° C., for example to 65° C., and the second temperature at around 100° C.

In addition, the reduced formation of condensate or dust is achieved by a special form of tempering the process fluid, namely that a transfer temperature below 800° C., in particular below 600° C., is maintained. It has been found that, among other things, the process fluid, which is operated as a circulating air, generates less dust formation.

Another advantage of the drying system described is that the formation of condensation and process residue can be specifically influenced, so that, for example, the condensate settles in a defined manner in the condensate chamber, thus simplifying the cleaning of the drying system.

REFERENCE SYMBOLS

| | |
|---|---|
| 100 | Drying system |
| 102 | Tins |
| 104 | Drying chamber |
| 106 | Drying line |
| 108 | Pre-heating section |
| 110 | First pre-heating chamber |
| 112 | Second pre-heating chamber |
| 114 | Polymerization chamber |
| 116 | First heating unit |
| 118 | Second heating unit |
| 120 | Third heating unit |
| 122 | Control device |
| 124 | Conveyor device |
| 126 | First exhaust fan |
| 128 | Second exhaust fan |
| 130 | Third exhaust fan |
| 132 | First exhaust air |
| 134 | Second exhaust air |
| 136 | Third exhaust air |
| 138 | First exhaust air duct |
| 140 | Second exhaust air duct |
| 142 | Third exhaust air duct |
| 144 | Condensate chamber |
| 146 | Condensate separator |
| 148 | Fluid interface |
| 150 | Mixing chamber |
| 152 | First combustion unit |
| 154 | First electric heating unit |
| 156 | Fluid recirculation unit |
| 158 | First cleaning unit |
| 160 | Second cleaning unit |
| 162 | Third cleaning unit |
| 164 | Second combustion unit |
| 166 | Second electric heating unit |
| 168 | Third combustion unit |
| 170 | Third electric heating unit |

1. A drying system for drying a coating for tins, comprising:
a drying chamber with a drying line having a pre-heating section and a polymerization chamber;
a conveyor device with which the tins can be moved through the drying chamber; and
a heating system for applying a temperature-controlled process fluid to the tins within the drying chamber,
wherein the heating system is coupled to a control device for signal communication, the pre-heating section has a first pre-heating chamber and a second pre-heating chamber downstream of the first pre-heating chamber, and the control device is designed to control the heating system such that the tins in the first pre-heating chamber are heated to a first temperature and the tins in the second pre-heating chamber are heated to a second temperature, wherein the second temperature is higher than the first temperature so that a temperature gradient of the tins along the drying line is low to such an extent that a sublimation of the tin coating is reduced in order to prevent condensate formation, and/or
wherein the heating system is arranged and designed to act on the process fluid at a transfer temperature of less than 800° C. so as to reduce particulate-containing combustion products to reduce particulate contamination.

2. The drying system of claim 1, wherein
the first pre-heating chamber, the second pre-heating chamber and the polymerization chamber each have an exhaust fan, so that a first exhaust air volume of an exhaust air of the first pre-heating chamber, a second exhaust air volume of an exhaust air of the second pre-heating chamber and a third exhaust air volume of an exhaust air of the polymerization chamber can be set independently of one another.

3. The drying system according to claim 1,
wherein the first pre-heating chamber comprises a first drying line, the second pre-heating chamber comprises a second drying line and the polymerization chamber comprises a polymerization line, and
the first drying line is longer than the second drying line, and/or
the first drying line and the second drying line together are longer than the polymerization line.

4. The drying system according to claim 1,
wherein the first pre-heating chamber, the second pre-heating chamber and the polymerization chamber each have an exhaust air duct for discharging exhaust air, so that the exhaust air of the first pre-heating chamber, the second pre-heating chamber, and the polymerization chamber are not essentially mixed with each other, thus reducing condensation in the exhaust air ducts.

5. The drying system according to claim 1,
wherein the exhaust air ducts open into a condensate chamber, and
the condensate chamber is arranged and configured to separate condensate from the exhaust air.

6. The drying system according to claim 1,
wherein the condensate chamber has a removable condensate separator.

7. The drying system according to claim 1, further comprising:
a fluid interface that is arranged and designed to fluidically and/or thermally couple the first pre-heating chamber and/or the second pre-heating chamber to a device for manufacturing tins, such that the process fluid introduced into the first pre-heating chamber and/or second pre-heating chamber can be at least partially provided by the device for manufacturing tins and/or can be thermally influenced by the device for manufacturing tins.

8. The drying system according to claim 1, wherein
the heating system comprises a combustion unit and/or an electric heating unit which is/are arranged and designed such that the transfer temperature is less than 800° C.

9. The drying system according to claim 1,
the combustion unit is or comprises a porous burner.

10. The drying system according to claim 1,
wherein fresh air can be supplied to the process fluid so that the temperature of the process fluid can be adjusted by a fresh air volume of the fresh air.

11. The drying system according to claim 1,
wherein an airlock is arranged between the first pre-heating chamber, the second pre-heating chamber and/or the polymerization chamber, such that during normal operation, fluid exchange between the first pre-heating chamber, the second pre-heating chamber and/or the polymerization chamber is at least reduced.

12. The drying system according to claim 1,
wherein the first pre-heating chamber, the second pre-heating chamber and/or the polymerization chamber comprises a cleaning unit that is arranged and designed to separate a condensate and/or particulates.

13. The drying system according to claim 1,
wherein the cleaning unit is designed to work mechanically, electrostatically and/or pressure-based.

14. A method for drying a coating for tins, comprising:
conveying the tins along a drying line with a first pre-heating chamber and a second pre-heating chamber downstream of the first pre-heating chamber;
heating the tins to a first temperature in the first pre-heating chamber by exposure to a temperature-controlled process fluid process fluid;
heating the tins to a second temperature in the second pre-heating chamber by exposure to a temperature-controlled process fluid, wherein the second temperature is higher than the first temperature, so that a temperature gradient of the tins along the drying line is low to such an extent that a sublimation of the tin coating is reduced in order to prevent condensate formation.

15. A method for drying a coating for tins, comprising:
conveying the tins along a drying line that has a pre-heating section and a polymerization chamber;
applying a temperature-controlled process fluid to the tins;
temperature-controlling the process fluid with a transfer temperature of less than 800° C., so that particulate-containing combustion products are reduced to minimize particulate contamination.

16. The drying system according to claim 1, wherein the first temperature is below 80° C., and the second temperature is below 120° C.

17. The method according to claim 14, wherein the first temperature is below 80° C., and the second temperature is below 120° C.
